(19) United States
(12) Patent Application Publication
(10) Pub. No.: US 2026/0162913 A1
(43) Pub. Date: Jun. 11, 2026

(54) DUAL POWER TRANSFER SWITCH

(71) Applicant: Schneider Electric Industries SAS, Rueil-Malmaison (FR)

(72) Inventors: Gang YU, Shanghai (CN); Zhenzhong LIU, Shanghai (CN)

(21) Appl. No.: 19/416,317

(22) Filed: Dec. 11, 2025

(30) Foreign Application Priority Data
Dec. 11, 2024 (CN) 2024118227545

(51) Int. Cl. H01H 1/20; H01H 3/38; H01H 3/46; H01H 3/32

(52) U.S. Cl. CPC H01H 1/2041; H01H 3/38; H01H 3/46; H01H 2003/326

(57) ABSTRACT

A dual power transfer switch, including: a first switch switchable between a first position and a second position; a second switch and a power electronic switch, connected in parallel and then in series with the first switch; the second switch switchable between a third position and a fourth position; and a driving mechanism, configured to switch between the first position and the second position and to switch between the third position and the fourth position, wherein in a first operating mode of the dual power transfer switch, the first switch is in the first position, the second switch is in the third position, and the power electronic switch is in the OFF state, in a second operating mode of the dual power transfer switch, the first switch is in the second position, the second switch is in the fourth position, and the power electronic switch is in the OFF state.

### CROSS-REFERENCE

This application claims priority to Chinese Patent Application No. 2024118227545, filed on December 11, 2024, and entitled “DUAL POWER TRANSFER SWITCH”, the entirety of which is incorporated herein by reference.

### TECHNICAL FIELD

The embodiments of the present disclosure relate to a dual power transfer switch.

### BACKGROUND

Dual power transfer switch is a switch used to switch between a common power supply and a standby power supply. The dual power transfer switches generally include a mechanical dual power transfer switch and a solid-state dual power transfer switch. The solid-state dual power transfer switch uses a power electronic switch (such as IGBT), and the switching speed is very fast, generally about us level. However, the overload capacity of IGBT itself is limited, and when IGBT is used, it often needs a large IGBT, which leads to a high cost. Moreover, the power consumption of solid-state dual power transfer switch is high, so it is needed to have complex heat dissipation design, such as air cooling and liquid cooling.

The switching speed of the mechanical dual power transfer switch is slow. However, the advantages of mechanical dual power transfer switch are low power consumption, low cost and high reliability. The mechanical dual power transfer has good heat dissipation, without air cooling and water cooling, can reach a relatively large rated current.

Therefore, it is desirable to develop a dual power transfer switch with fast switching speed (for example, within 10ms) without excessive cost.

### SUMMARY

In order to overcome the abovementioned problems, the present disclosure provides a dual power transfer switch, configured to be switchable between a first power supply and a second power supply, which is characterized in that the dual power transfer switch includes:

a first switch, including a first movable contact configured to be rotatable between a first position and a second position, in the first position, the first movable contact is used to connect the first power supply with a first stationary contact, in the second position, the first movable contact is used to connect the second power supply with a second stationary contact;

a second switch and a power electronic switch, which are connected in parallel and then connected in series with the first switch, the second switch includes a second movable contact, and the second movable contact is configured to be switchable between a third position and a fourth position, and in both the third position and the fourth position, the second movable contact is electrically connected with a load, and the power electronic switch is configured to be switchable between an ON state and an OFF state; and a driving mechanism, configured to drive the first movable contact to switch between the first position and the second position and to drive the second movable contact to switch between the third position and the fourth position,

in a first power supply operating mode of the dual power transfer switch, the first movable contact is in the first position, the second movable contact is in the third position, and the power electronic switch is in the OFF state.

in a second power supply operating mode of the dual power transfer switch, the first movable contact is in the second position, the second movable contact is in the fourth position, and the power electronic switch is in the OFF state.

during a switching process of the dual power transfer switch from the first power supply operating mode to the second power supply operating mode, the power electronic switch first switches to the ON state, then the driving mechanism drives the second movable contact to switch from the third position to the fourth position, and then the power electronic switch switches to the OFF state, and the driving mechanism drives the first movable contact to switch from the first position to the second position, and drives the second movable contact to switch from the third position to the fourth position.

Advantageously, the driving mechanism includes:

a first main shaft, rotatably arranged in a housing of the dual power transfer switch and configured to rotate under an action of a first main spring driving assembly, the first main spring driving assembly is configured to be switched between a first state and a second state, in the first state, the first main spring driving assembly is configured to provide a biasing force for pivoting the first main shaft in a first direction, and in the second state, the first main spring driving assembly is configured to provide a biasing force for pivoting the first main shaft in a second direction opposite to the first direction;

a first bracket, fixedly installed on the first main shaft and carrying the first movable contact;

a second main shaft, rotatably arranged in the housing of the dual power transfer switch and configured to rotate under an action of a second main spring driving assembly, the second main spring driving assembly is configured to be switched between a first state and a second state, in the first state, the second main spring driving assembly is configured to provide a biasing force for pivoting the second main shaft in a first direction, and in a second state, the second main spring driving assembly is configured to provide a biasing force for pivoting the second main shaft in a second direction opposite to the first direction; and

a second bracket, fixedly installed on the second main shaft and carrying the second movable contact.

Advantageously, the driving mechanism further includes:

a first locking piece, rotatably arranged in the housing of the dual power transfer switch and configured to be rotatable between a locked position and an unlocked position, in the locked position, the first locking member abuts against the first main shaft to block a rotation of the first main shaft, and in the unlocked position, the first locking member is out of abutment with the first main shaft and allows the first main shaft to rotate;

a second locking piece, rotatably arranged in the housing of the dual power transfer switch and configured to be rotatable between a locked position and an unlocked position, in the locked position, the second locking member abuts against the second main shaft to block a rotation of the second main shaft, and in the unlocked position, the second locking member is out of abutment with the second main shaft and allows the second main shaft to rotate.

Advantageously, the driving mechanism includes:

a first actuator, configured to enable the first locking member to switch between the locked position and the unlocked position;

a second actuator, configured to enable the second locking member to switch between the locked position and the unlocked position.

Advantageously, the driving mechanism further includes an interlocking member pivotally installed in the housing and including a first opening and a second opening, the first main shaft includes a first pin inserted into the first opening and configured to move in the first opening, and the second main shaft includes a second pin inserted into the second opening and configured to move in the second opening.

Advantageously, during the switching process of the dual power transfer switch from the first power supply operating mode to the second power supply operating mode, after the power electronic switch is switched to the ON state, the second actuator drives the second locking member to switch from the locked position to the unlocked position, and the second main shaft pivots in the first direction under the action of the second main spring assembly, so that the second bracket drives the second movable contact to move away from the third position towards the fourth position, after the second bracket moves away from the third position, the power electronic switch is switched to the OFF state, the second pin abuts against a corresponding wall of the second opening, and the first pin abuts against a corresponding wall of the first opening.

Advantageously, in a locked position of the first locking piece, the first pin abuts against a corresponding wall of the first opening of the interlocking member, thereby preventing the second pin from pushing the interlocking member to rotate in the first direction, and further preventing the first main shaft from continuing to rotate in the first direction.

Advantageously, after the first actuator drives the first locking member to switch from the locked position to the unlocked position, the first main shaft pivots in the first direction under the action of the first main spring assembly, so that the first bracket drives the first movable contact to move away from the first position towards the second position, and the first pin is disengaged from the corresponding wall of the first opening of the interlocking member, allowing the second main shaft to continue to rotate in the first direction, finally, the first bracket drives the first movable contact to the second position, and the second main shaft drives the second bracket and the second movable contact to the fourth position, then, the first main spring assembly is switched to the second state, and the second main spring assembly is switched to the second state.

Advantageously, the dual power transfer switch further includes a fuse, connected in series with the power electronic switch and then connected in parallel with the second switch.

Advantageously, the dual power transfer switch further including a detection device electrically connected to a main loop of the dual power transfer switch and configured to detect whether there is current in the main loop of the dual power transfer switch after the power electronic switch is switched from the ON state to the OFF state, upon the detection device detecting no current in the main loop, the driving mechanism starts to drive the first movable contact to switch from the first position to the second position, and drives the second movable contact to switch from the third position to the fourth position.

Advantageously, the power electronic switch is an IGBT.

Advantageously, the first actuator is an electromagnetic actuator and the second actuator is an electromagnetic actuator.

Advantageously, each of the first main spring driving assembly and the second main spring driving assembly includes:

a pivot rod, pivotally installed on the housing;

a first bearing rod, one end of the first bearing rod is provided with a first long slot, a first column passes through the first long slot and is fixed to the housing, and another end of the first bearing rod is pivotally installed to the pivot rod through a first pivot column, and the first pivot column abuts against a part of a corresponding main shaft;

a second bearing rod, one end of the second bearing rod is provided with a second long slot, a second column passes through the second long slot and is fixed to the housing, and another end of the second bearing rod is pivotally installed to the pivot rod through a second pivot column, and the second pivot column abuts against another part of the corresponding main shaft;

a first main spring, arranged between the first column and the first pivot column;

a second main spring, arranged between the second column and the second pivot column,

the first main spring and the second main spring are configured to provide a biasing force to pivot a corresponding main shaft in a first direction through the first pivot column in the first state and to provide a biasing force to pivot the corresponding main shaft in a second direction opposite to the first direction through the second pivot column in the second state.

### BRIEF DESCRIPTION OF DRAWINGS

The above and other features and advantages of exemplary embodiments of the present disclosure will become more apparent from the following detailed description taken in conjunction with the accompanying drawings, which are for illustrative purposes only and are not intended to limit the scope of the present disclosure in any way, in which:

FIG. 1 shows a schematic diagram of a dual power transfer switch according to the present disclosure, in this case, the dual power transfer switch is in a first power supply operating mode, a first movable contact of a first switch is in a first position, and a second movable contact of a second switch is in a third position.

FIG. 2 shows a circuit diagram corresponding to FIG. 1.

FIG. 3 shows a schematic diagram of a dual power transfer switch according to the present disclosure, in this case, a second movable contact of a second switch moves away from a third position towards a fourth position.

FIG. 4 shows a circuit diagram corresponding to FIG. 3.

FIG. 5 shows a schematic diagram of a dual power transfer switch according to the present disclosure, in this case, a first movable contact of a first switch moves away from a first position towards a second position.

FIG. 6 shows a circuit diagram corresponding to FIG. 5.

FIG. 7 shows a schematic diagram of a dual power transfer switch according to the present disclosure, in this case, a second movable contact of a second switch reaches a fourth position.

FIG. 8 shows a circuit diagram corresponding to FIG. 7.

FIG. 9 shows a schematic diagram of a dual power transfer switch according to the present disclosure, in this case, a first contact of a first switch reaches a second position.

FIG. 10 shows a circuit diagram corresponding to FIG. 9.

FIG. 11 shows a schematic diagram of a dual power transfer switch according to the present disclosure, in this case, both the first main spring assembly and the second main spring assembly are switched to a second state.

FIG. 12 shows a rear schematic view of the dual power transfer switch corresponding to FIG. 3, showing an interlocking member.

### DETAILED DESCRIPTION

In order to make the purpose, technical details and advantages of the technical solution of the present disclosure more clear, the technical solution of the embodiment of the present disclosure will be described clearly and completely with the accompanying drawings of specific embodiments of the present disclosure. Like reference numerals in the drawings represent like parts. It should be noted that the described embodiments is a part of the embodiment of the present disclosure, not the whole embodiments. Based on the described embodiments of the present disclosure, all other embodiments obtained by ordinary skilled in the art without creative labor belong to the scope of protection of the present disclosure.

Compared with the embodiments shown in the attached drawings, the feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The words “first”, “second” and similar words used in the specification and claims of the patent application of the present disclosure do not indicate any order, quantity or importance, but are only used to distinguish different components. When the number of parts is not specified, the number of parts can be one or more; Similarly, similar words such as “a”, “an” and “the” do not necessarily mean quantity limitation. Similar words such as “including” or “comprising” mean that the elements or objects appearing before the word cover the elements or objects listed after the word and their equivalents, without excluding other elements or objects. “Up”, “Down”, “Left” and “Right” are only used to indicate the relative orientation relationship when the equipment is used or the orientation relationship shown in the attached drawings. When the absolute position of the described object changes, the relative orientation relationship may also change accordingly.

FIG. 1 shows a schematic diagram of a dual power transfer switch according to the present disclosure, in this case, the dual power transfer switch is in a first power supply operation mode. In the description of the present disclosure, for the sake of simplicity, the electrical connections between the first power supply, the second power supply and the load are shown in a simplified form.

The dual power transfer switch is configured to be able to switch between a first power supply S1 and a second power supply S2. In the first power supply working mode, the first power supply S1 and a load L form a main loop and are electrically connected with each other, and the first power supply S1 supplies power to the load L; in the second power supply operation mode, the second power supply S2 and the load L form a main loop and are connected with each other, and the second power supply S2 supplies power to the load L. The electrical connection between the first power supply, the second power supply and the load is schematically shown in the figure, and those skilled in the art will understand how to electrically connect the first power supply, the second power supply and the load.

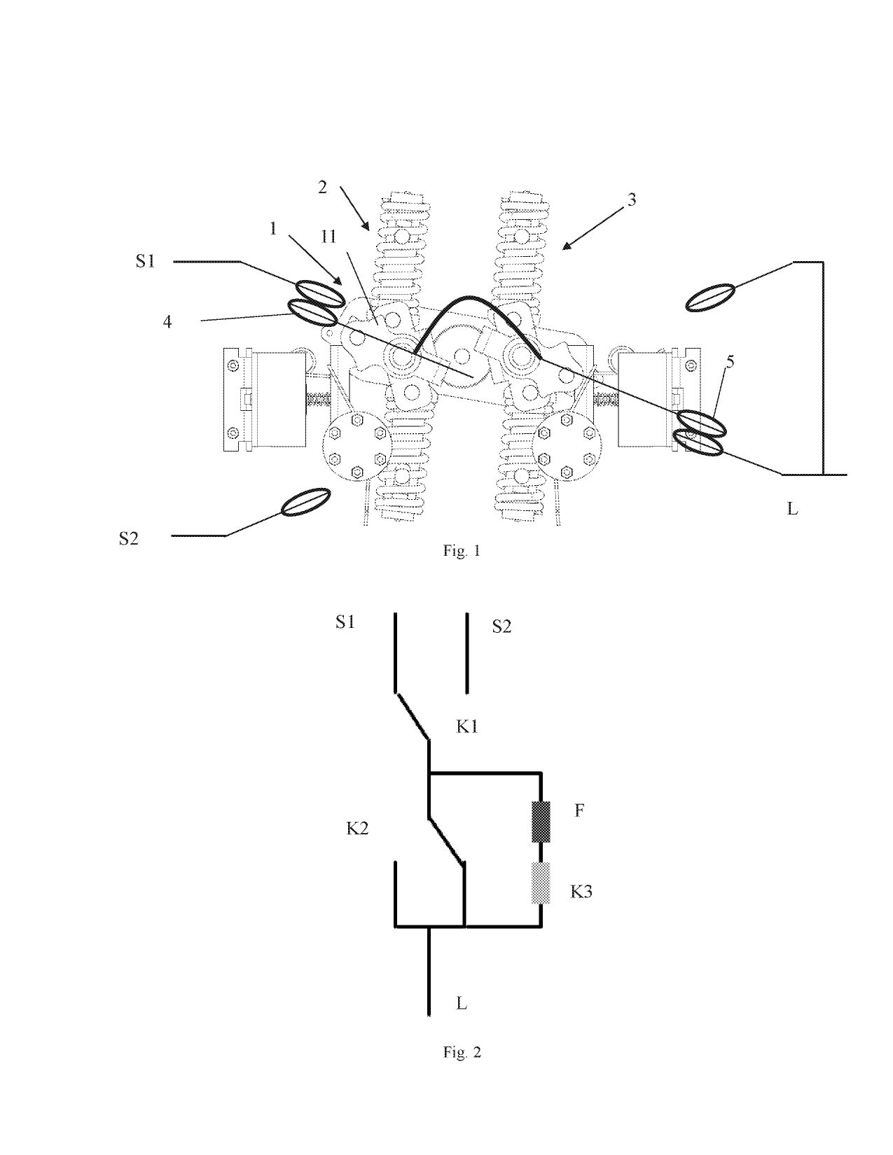

As illustrated by FIG. 2, the dual power transfer switch includes a first switch K1 including a first movable contact 4 configured to be rotatable between a first position and a second position, in the first position, the first movable contact is used to connect the first power supply with a first stationary contact, in the second position, the first movable contact is used to connect the second power supply with a second stationary contact.

A second switch K2 and a power electronic switch K3 are connected in parallel with each other and then connected in series with the first switch K1. The second switch includes a second movable contact 5 configured to be switchable between a third position and a fourth position. In both the third position and the fourth position, the second movable contact is electrically connected with a load, and the power electronic switch is configured to be switchable between an ON state and an OFF state. In the embodiment of the present disclosure, the power electronic switch is IGBT, but it should be understood by those skilled in the art that the power electronic switch can be in other forms as long as it can realize electronic turn-off of current.

A driving mechanism 1 is configured to drive the first movable contact to switch between a first position and a second position, and to drive the second movable contact to switch between a third position and a fourth position.

As illustrated by FIGS. 1 and 2, the dual power transfer switch is in the first power supply working mode, the first movable contact is in the first position, the second movable contact is in the third position, and the power electronic switch is in the OFF state, so that the first power supply S1 supplies power to the load. During a switching process of the dual power transfer switch from the first power supply operating mode to the second power supply operating mode, the power electronic switch K3 is first switched to the ON state, then the driving mechanism drives the second movable contact to switch from the third position to the fourth position, and then the power electronic switch is switched to the OFF state. The driving mechanism 1 drives the first movable contact to switch from the first position to the second position, and drives the second movable contact to switch from the third position to the fourth position.

Referring to FIG. 1, the driving mechanism 1 includes a first main shaft 11 rotatably arranged in a housing of a dual power transfer switch and configured to be rotatable under an action of a first main spring driving assembly 2, which can be switched between a first state and a second state, in the first state, the first main spring driving assembly is configured to provide a biasing force to pivot the first main shaft in a first direction, and in the second state, the first main spring driving assembly is configured to provide a biasing force to pivot the first main shaft in a second direction opposite to the first direction. A first bracket (not shown) is fixedly installed to the first main shaft 11 and carries the first movable contact.

The driving mechanism also includes a second main shaft 12 rotatably arranged in the housing of the dual power transfer switch and configured to rotate under an action of a second main spring driving assembly 3, which can be switched between a first state and a second state, in the first state, the second main spring driving assembly is configured to provide a biasing force for pivoting the second main shaft in a first direction, and in the second state, the second main spring driving assembly is configured to provide a biasing force for pivoting the second main shaft in a direction opposite to the first direction. A second bracket (not shown) is fixedly installed to the second main shaft and carries the second movable contact.

The first main spring assembly 2 and the second main spring assembly 3 have the same structure, and both include: a pivot rod 21 pivotally installed on the housing; a first bearing rod 22, one end of the first bearing rod 22 includes a first long slot 221, a first column 222 passes through the first long slot 221 and is fixed to the housing, and the other end of the first bearing rod 22 is pivotally installed to the pivot rod 21 through a first pivot column 223, which abuts against a part of a corresponding main shaft; a second bearing rod 23, one end of the second bearing rod 23 includes a second long slot 231, a second column 232 passes through the second long slot 231 and is fixed to the housing, and the other end of the second bearing rod 23 is pivotally installed to the pivot rod 21 through a second pivot column 233 which abuts against another part of the corresponding main shaft; a first main spring 24 arranged between the first column and the first pivot column; a second main spring 25 is arranged between the second column and the second pivot column. The first main spring 24 and the second main spring 25 are configured to provide a biasing force to pivot a corresponding main shaft in a first direction through the first pivot column in the first state, and to provide a biasing force to pivot the corresponding main shaft in a second direction opposite to the first direction through the second pivot column in the second state.

The driving mechanism further includes a first locking member 13 rotatably arranged in the housing of the dual power transfer switch and configured to be rotatable between a locked position and an unlocked position, in the locked position, the first locking member abuts against the first main shaft so as to block a rotation of the first main shaft, and, in an unlocked position, the first locking member is out of abutment with the first main shaft and allows the first main shaft to rotate; A second locking member 14 rotatably arranged in the housing of the dual power transfer switch and configured to be rotatable between a locked position, in which the second locking member abuts against the second main shaft so as to block the rotation of the second main shaft, and an unlocked position, in which the second locking member is out of abutment with the second main shaft and allows the second main shaft to rotate.

The driving mechanism includes a first actuator 15 configured to switch the first locking member 13 between a locked position and an unlocked position; a second actuator 16 configured to switch the second locking member 14 between a locked position and an unlocked position. The first actuator and the second actuator are in the form of electromagnetic actuators, which are well known to those skilled in the art, so they will not be described in detail here.

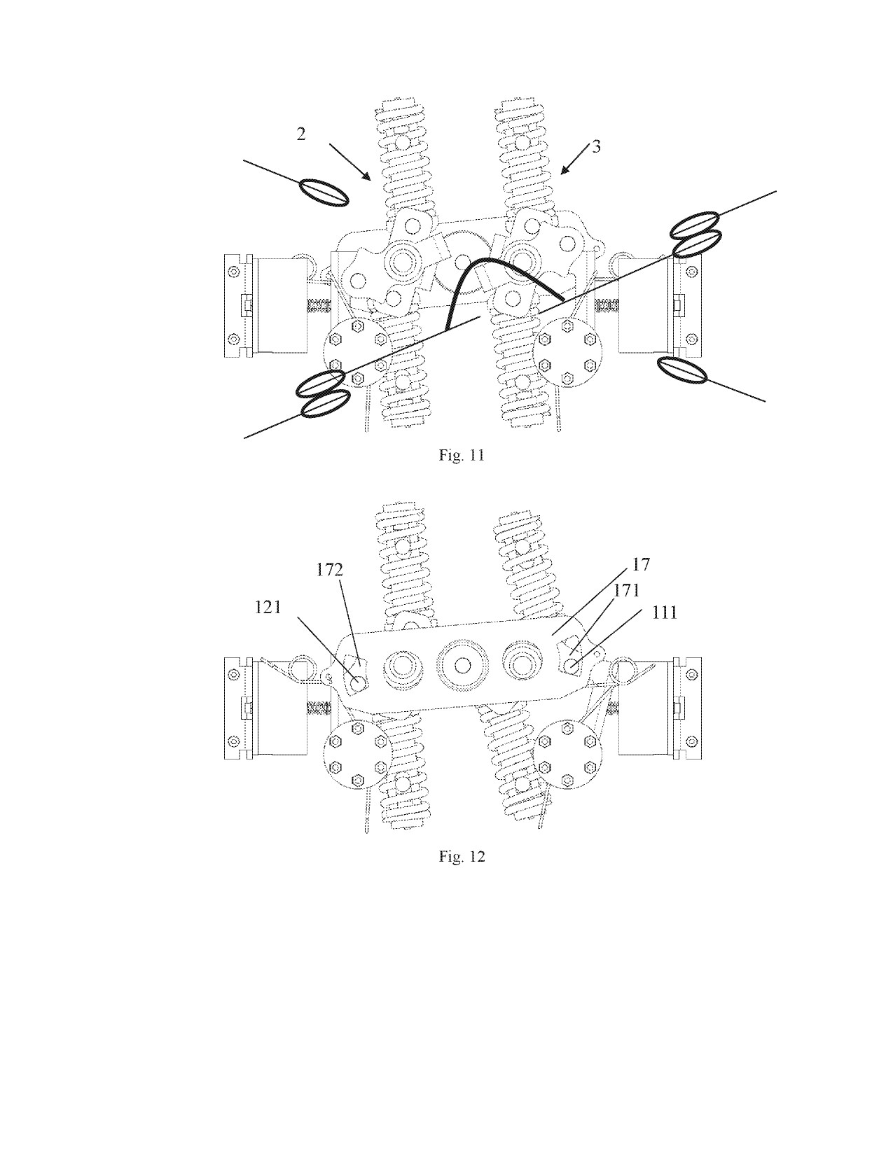

As illustrated by FIG. 12, the driving mechanism further includes an interlocking member 17 pivotally installed in the housing and including a first opening 171 and a second opening 172. The first main shaft 11 includes a first pin 111 inserted into the first opening and configured to move in the first opening, and the second main shaft 12 includes a second pin 121 inserted into the second opening and configured to move in the second opening.

Hereinafter, an operating process of a switching process of the dual power transfer switch from the first power supply operation mode to the second power supply operation mode will be described.

As illustrated by FIGS. 1 and 2, the dual power transfer switch is in the first power supply working mode. In this case, the first movable contact is in the first position, the second movable contact is in the third position, and the power electronic switch is in the OFF state, so that the first power supply S1 supplies power to the load.

When it is needed to switch to the second power supply operation mode, firstly, the power electronic switch K3 is switched from the OFF state to the ON state, resulting in the current flowing through the power electronic switch without flowing through the second switch K2. Next, the second actuator 16 pulls the second locking member 14 so that the second locking member 14 moves from the locked position to the unlocked position. As a result, the second main shaft 12 pivots in the first direction (counterclockwise direction in FIG. 1) under the action of the second main spring assembly, so that the second bracket drives the second movable contact to move from the third position to the fourth position.

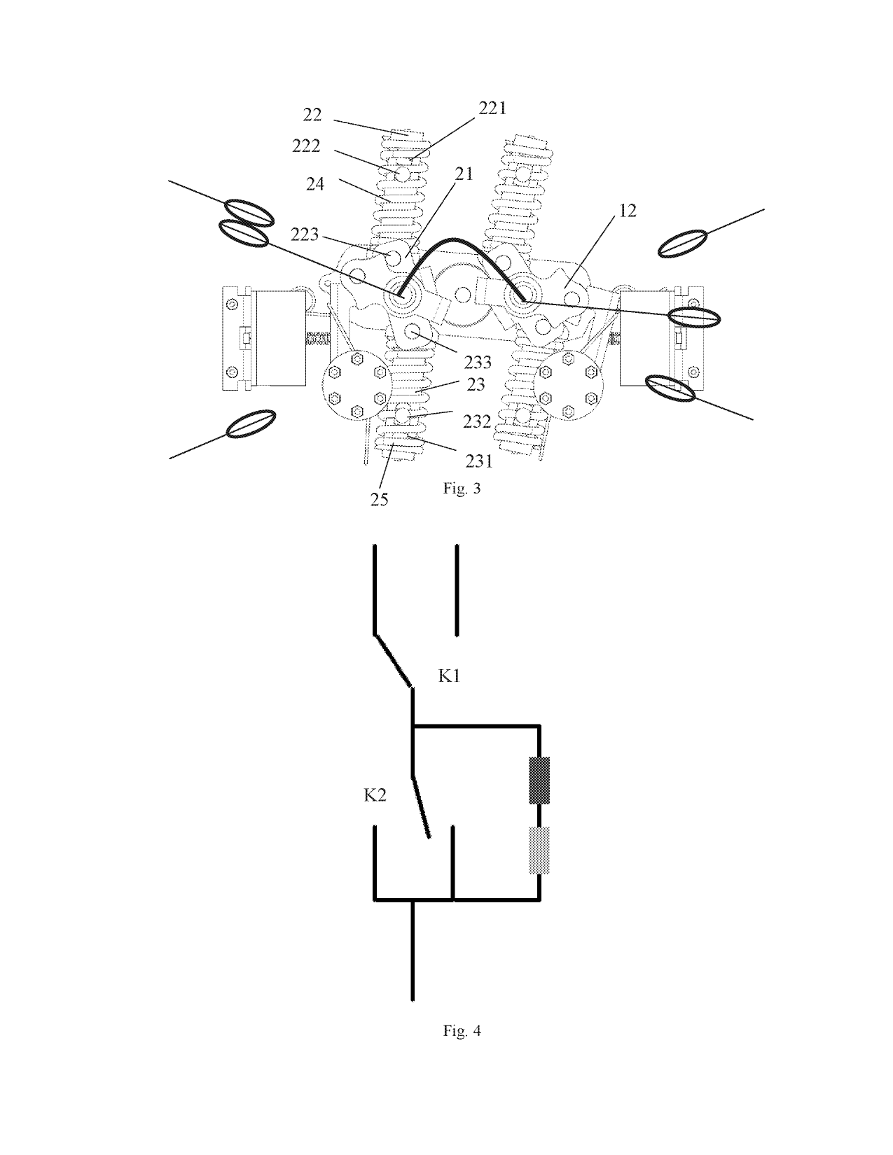

After the second movable contact leaves the third position, as illustrated by FIGS. 3 and 4, the power electronic switch is switched to the OFF state. In this case, the second pin 121 of the second main shaft 12 abuts against a corresponding wall of the second opening 172 of the interlocking member 17, and the first pin 111 of the first main shaft 11 abuts against a corresponding wall of the first opening 171 of the interlocking member 17, as illustrated by FIG. 12. In this case, with the first locking member 13 in the locked position, the first pin 111 of the first main shaft 11 abuts against the corresponding wall of the first opening 171 of the interlocking member 13, which prevents the second pin 121 from pushing the interlocking member 17 to rotate in the first direction, thereby preventing the first main shaft 111 from continuing to rotate in the first direction.

Through the interlocking member, it can be ensured that the second movable contact of the second switch will not move to the fourth position if the arc of the main loop is not extinguished, and it can also be ensured that the first movable contact of the first switch has left the third position before the second movable contact of the second switch moves to the fourth position.

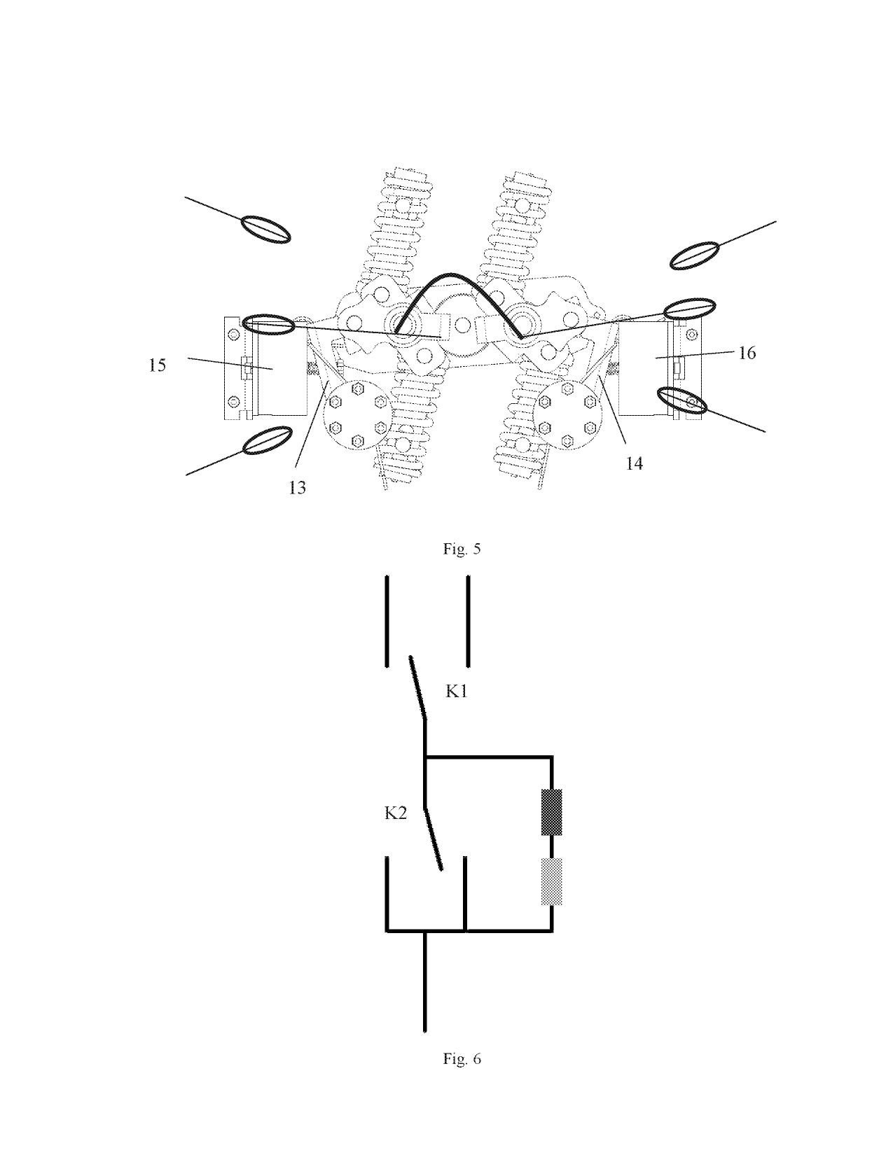

Next, a detection device electrically connected to the main loop of the dual power transfer switch detects whether there is current in the main loop of the dual power transfer switch. When there is current in the main loop, a fuse F fuses, the fuse F is connected in series with the power electronic switch K3 and then connected in parallel with the second switch K2; when the detection device detects no current in the main loop, the first actuator 15 pulls the first locking member 13 to move the first locking member 13 from the locked position to the unlocked position, so that the first locking member is out of abutment with the main shaft (as illustrated by FIG. 5). As a result, the first main shaft 11 rotates in the first direction (counterclockwise direction in FIG. 5) under the action of the first main spring assembly 2, so that the first bracket drives the first movable contact to leave the first position, as illustrated by FIGS. 5 and 6.

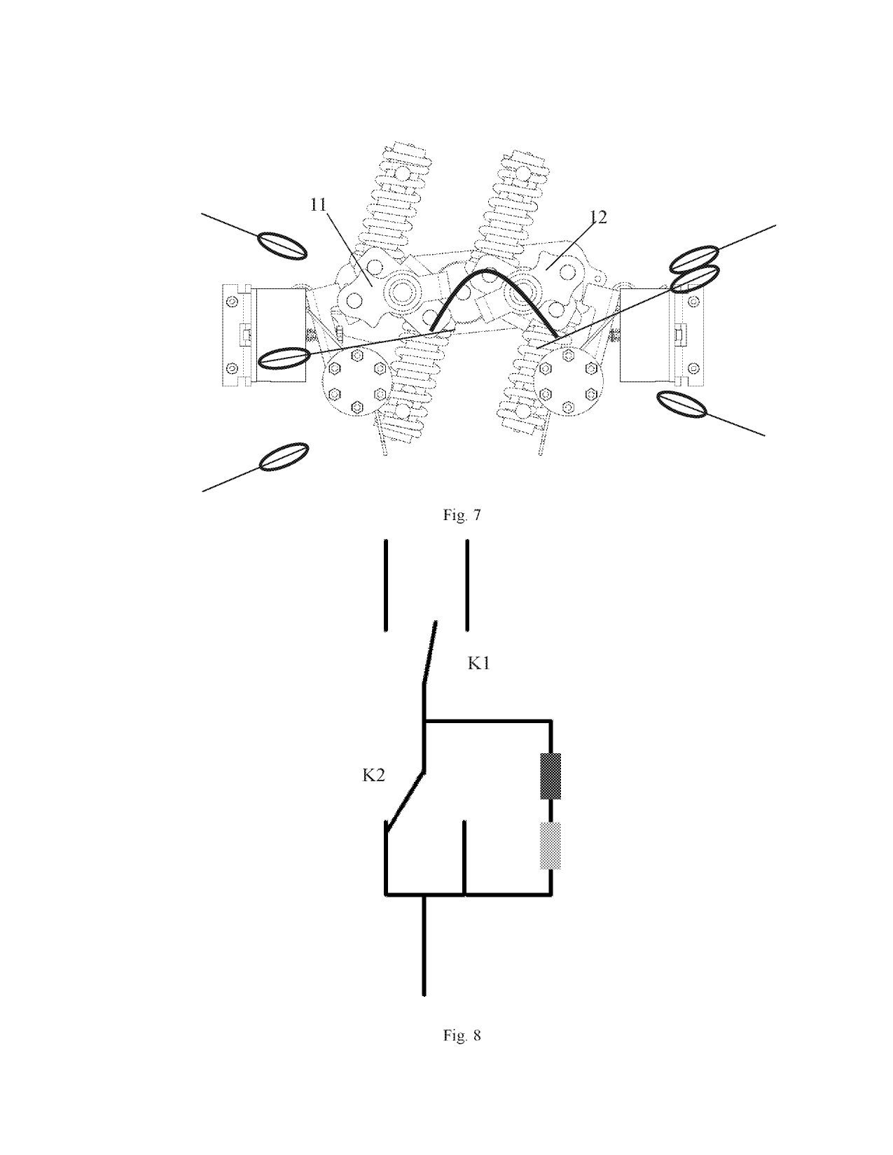

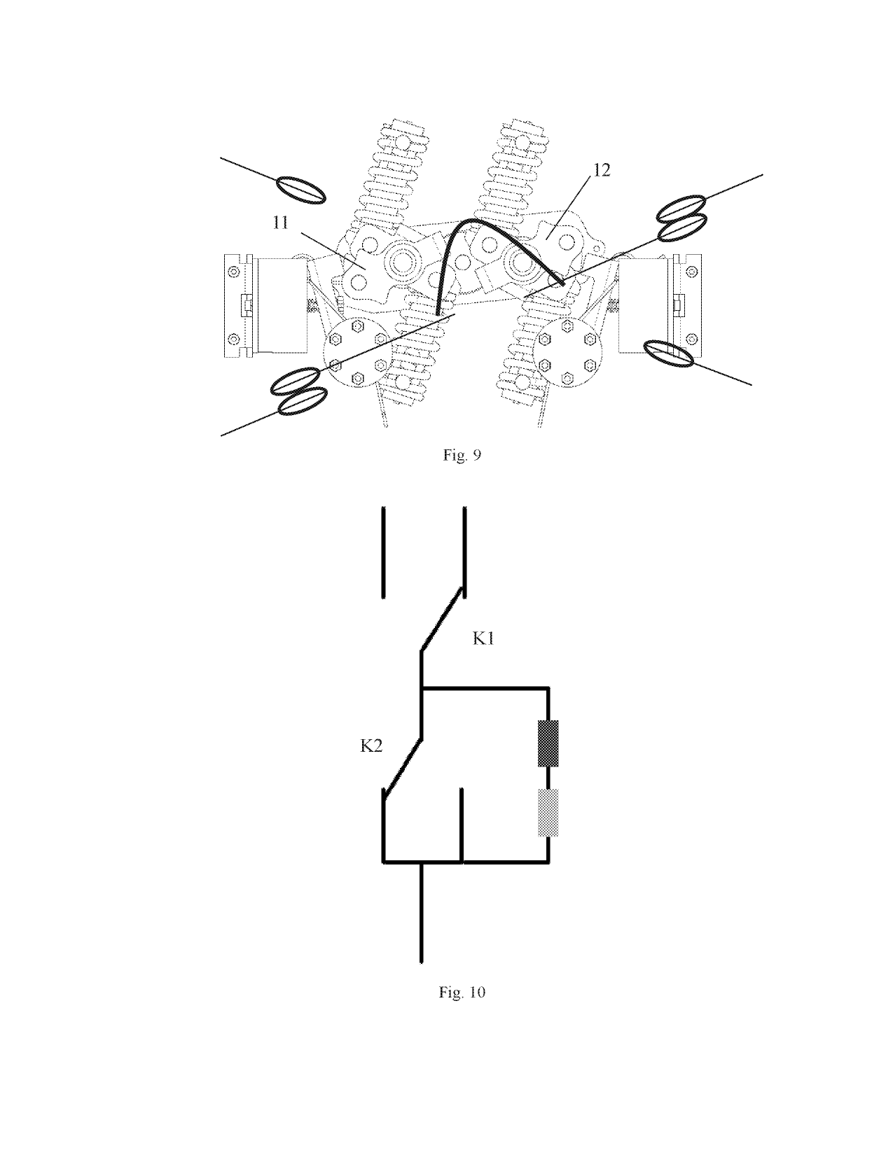

The first bracket drives the first movable contact to move from the first position to the second position, which causes the first pin 111 to break away from the abutment with a corresponding wall of the first opening 171 of the interlocking member 17, thereby allowing the second main shaft 12 to continue to rotate in the first direction, and finally the second main shaft drives the second bracket and the second movable contact to the fourth position, as illustrated by FIGS. 7 and 8. The first main shaft also continues to rotate in the first direction, so that the first movable contact reaches the second position, as illustrated by FIGS. 9 and 10.

Thereafter, the first actuator and the second actuator respectively actuate the first locking member and the second locking member to return to their respective locked positions, and the first main spring assembly and the second main spring assembly are respectively switched to their respective second states, as illustrated by FIG. 11, so that they can be used for switching from the second power supply operation mode to the first power supply operation mode.

The switching process of the dual power transfer switch from the second power supply working mode to the first power supply working mode is similar to the above process, so it will not be described in detail here.

With the dual power transfer switch, a small number of IGBT (only one) can be used, and at the same time, a fast switching speed can be achieved, for example, within 10ms. At the same time, the first power supply and the second power supply are completely isolated.

Although the present disclosure has been described in the specification and illustrated in the drawings on the basis of referring to various embodiments, those skilled in the art can understand that the above-mentioned embodiments are only preferred embodiments, and some technical features in the embodiments may not be necessary for solving specific technical problems, so these technical features may not be needed or omitted without affecting the solution of technical problems or the formation of technical solutions; Moreover, the features, elements and/or functions of one embodiment can be combined, combined or coordinated with those of one or more other embodiments as appropriate, unless the combination, combination or coordination is obviously impracticable.

1. A dual power transfer switch, configured to be switchable between a first power supply and a second power supply, which is characterized in that the dual power transfer switch includes:
a first switch, including a first movable contact configured to be rotatable between a first position and a second position, wherein, in the first position, the first movable contact is used to connect the first power supply with a first stationary contact, in the second position, the first movable contact is used to connect the second power supply with a second stationary contact;
a second switch and a power electronic switch, which are connected in parallel and then connected in series with the first switch, wherein, the second switch includes a second movable contact, and the second movable contact is configured to be switchable between a third position and a fourth position, and in both the third position and the fourth position, the second movable contact is electrically connected with a load, and the power electronic switch is configured to be switchable between an ON state and an OFF state; and
a driving mechanism, configured to drive the first movable contact to switch between the first position and the second position and to drive the second movable contact to switch between the third position and the fourth position,
wherein, in a first power supply operating mode of the dual power transfer switch, the first movable contact is in the first position, the second movable contact is in the third position, and the power electronic switch is in the OFF state;
wherein in a second power supply operating mode of the dual power transfer switch, the first movable contact is in the second position, the second movable contact is in the fourth position, and the power electronic switch is in the OFF state;
wherein during a switching process of the dual power transfer switch from the first power supply operating mode to the second power supply operating mode, the power electronic switch is configured to first switch to the ON state, and then the driving mechanism is configured to drive the second movable contact to switch from the third position to the fourth position, and then the power electronic switch is configured to switch to the OFF state, and the driving mechanism is configured to drive the first movable contact to switch from the first position to the second position, and drive the second movable contact to switch from the third position to the fourth position.

2. The dual power transfer switch according to claim 1, wherein the driving mechanism includes:
a first main shaft, rotatably arranged in a housing of the dual power transfer switch and configured to rotate under an action of a first main spring driving assembly, wherein the first main spring driving assembly is configured to be switched between a first state and a second state, in the first state, the first main spring driving assembly is configured to provide a biasing force for pivoting the first main shaft in a first direction, and in the second state, the first main spring driving assembly is configured to provide a biasing force for pivoting the first main shaft in a second direction opposite to the first direction;
a first bracket, fixedly installed on the first main shaft and carrying the first movable contact;
a second main shaft, rotatably arranged in the housing of the dual power transfer switch and configured to rotate under an action of a second main spring driving assembly, wherein the second main spring driving assembly is configured to be switched between a first state and a second state, in the first state, the second main spring driving assembly is configured to provide a biasing force for pivoting the second main shaft in a first direction, and in a second state, the second main spring driving assembly is configured to provide a biasing force for pivoting the second main shaft in a second direction opposite to the first direction; and
a second bracket, fixedly installed on the second main shaft and carrying the second movable contact.

3. The dual power transfer switch according to claim 2, wherein the driving mechanism further includes:
a first locking piece, rotatably arranged in the housing of the dual power transfer switch and configured to be rotatable between a locked position and an unlocked position, wherein, in the locked position, the first locking member abuts against the first main shaft to block a rotation of the first main shaft, and in the unlocked position, the first locking member is out of abutment with the first main shaft and allows the first main shaft to rotate;
a second locking piece, rotatably arranged in the housing of the dual power transfer switch and configured to be rotatable between a locked position and an unlocked position, wherein, in the locked position, the second locking member abuts against the second main shaft to block a rotation of the second main shaft, and in the unlocked position, the second locking member is out of abutment with the second main shaft and allows the second main shaft to rotate.

4. The dual power transfer switch according to claim 3, wherein the driving mechanism includes:
a first actuator, configured to enable the first locking member to switch between the locked position and the unlocked position;
a second actuator, configured to enable the second locking member to switch between the locked position and the unlocked position.

5. The dual power transfer switch according to claim 4, wherein the driving mechanism further includes an interlocking member pivotally installed in the housing and including a first opening and a second opening, wherein the first main shaft includes a first pin inserted into the first opening and configured to move in the first opening, and the second main shaft includes a second pin inserted into the second opening and configured to move in the second opening.

6. The dual power transfer switch according to claim 5, wherein during the switching process of the dual power transfer switch from the first power supply operating mode to the second power supply operating mode, after the power electronic switch is switched to the ON state, the second actuator is configured to drive the second locking member to switch from the locked position to the unlocked position, and the second main shaft is configured to pivot in the first direction under the action of the second main spring assembly, so that the second bracket drives the second movable contact to move away from the third position towards the fourth position, after the second bracket moves away from the third position, the power electronic switch is switched to the OFF state, the second pin abuts against a corresponding wall of the second opening, and the first pin abuts against a corresponding wall of the first opening.

7. The dual power transfer switch according to claim 6, wherein, in a locked position of the first locking piece, the first pin abuts against a corresponding wall of the first opening of the interlocking member, thereby preventing the second pin from pushing the interlocking member to rotate in the first direction, and further preventing the first main shaft from continuing to rotate in the first direction.

8. The dual power transfer switch according to claim 7, wherein, after the first actuator drives the first locking member to switch from the locked position to the unlocked position, the first main shaft is configured to pivot in the first direction under the action of the first main spring assembly, so that the first bracket drives the first movable contact to move away from the first position towards the second position, and the first pin is disengaged from the corresponding wall of the first opening of the interlocking member, allowing the second main shaft to continue to rotate in the first direction, finally, the first bracket drives the first movable contact to the second position, and the second main shaft drives the second bracket and the second movable contact to the fourth position, then, the first main spring assembly is switched to the second state, and the second main spring assembly is switched to the second state.

9. The dual power transfer switch according to claim 1, wherein the dual power transfer switch further includes a fuse, connected in series with the power electronic switch and then connected in parallel with the second switch.

10. The dual power transfer switch according to claim 9, wherein the dual power transfer switch further includes a detection device electrically connected to a main loop of the dual power transfer switch and configured to detect whether there is current in the main loop of the dual power transfer switch after the power electronic switch is switched from the ON state to the OFF state,
upon the detection device detecting no current in the main loop, the driving mechanism is configured to start driving the first movable contact to switch from the first position to the second position, and drives the second movable contact to switch from the third position to the fourth position.

11. The dual power transfer switch according to claim 1, wherein the power electronic switch is an IGBT.

12. The dual power transfer switch of claim 4, wherein the first actuator is an electromagnetic actuator and the second actuator is an electromagnetic actuator.

13. The dual power transfer switch according to claim 8, wherein each of the first main spring driving assembly and the second main spring driving assembly includes:
a pivot rod, pivotally installed on the housing;
a first bearing rod, wherein one end of the first bearing rod is provided with a first long slot, a first column passes through the first long slot and is fixed to the housing, and another end of the first bearing rod is pivotally installed to the pivot rod through a first pivot column, and the first pivot column abuts against a part of a corresponding main shaft;
a second bearing rod, wherein one end of the second bearing rod is provided with a second long slot, a second column passes through the second long slot and is fixed to the housing, and another end of the second bearing rod is pivotally installed to the pivot rod through a second pivot column, and the second pivot column abuts against another part of the corresponding main shaft;
a first main spring, arranged between the first column and the first pivot column;
a second main spring, arranged between the second column and the second pivot column,
wherein the first main spring and the second main spring are configured to provide a biasing force to pivot a corresponding main shaft in a first direction through the first pivot column in the first state and to provide a biasing force to pivot the corresponding main shaft in a second direction opposite to the first direction through the second pivot column in the second state.
